(19) United States
(12) Patent Application Publication
(10) Pub. No.: US 2026/0309511 A1
(43) Pub. Date: Oct. 8, 2026

(54) VEHICLE SPEED OR TRAVEL TIME ESTIMATION

(71) Applicant: GRABTAXI HOLDINGS PTE. LTD., Singapore (SG)

(72) Inventors: Suriyanarayanan VENKATESAN, Singapore (SG); Chen LIANG, Singapore (SG); Padarn George WILSON, Singapore (SG)

(21) Appl. No.: 18/998,286

(22) PCT Filed: Aug. 2, 2023
(86) PCT No.: PCT/SG2023/050536

§ 371 Date: Jan. 24, 2025

(30) Foreign Application Priority Data
Aug. 11, 2022 (SG) 10202250711M

(51) Int. Cl. G01C 21/36; G06N 7/06

(52) U.S. Cl. CPC G01C 21/3691; G06N 7/06

(57) ABSTRACT

Systems and methods for estimation of vehicle speed or travel time along a stretch of road, by computing a prior vehicle speed statistical distribution based on historical vehicle speed data along the road; receiving an observed vehicle speed data, performing Bayesian fusion of the prior and the observed vehicle speed data to determine a posterior vehicle speed distribution; and determining a vehicle speed estimate or a travel time estimate based on the posterior vehicle speed distribution.

### TECHNICAL FIELD

This disclosure generally relates to methods and systems for traffic speed and/or travel time estimation.

### BACKGROUND

This background is provided for the purpose of generally presenting the context of the disclosure. Contents of this background section are neither expressly nor impliedly admitted as prior art against the present disclosure.

Traffic movement speed, particularly in urban environments is subject to a great degree of natural variability due to weather conditions, events in an area, changes in the flow of traffic, construction along roads, accidents and other unpredictable conditions or events. Conventional systems and methods of traffic speed estimation rely on real-time traffic data or floating car data to estimate the speed of traffic or vehicles in a particular stretch of road (road segment). Such conventional systems rely on confidence thresholds such as the number of samples, unique vehicle counts, etc of real-time or recent traffic speed data originating from travelling vehicles.

However, the conventional floating car data is susceptible to errors or inaccuracies originating from several causes including GPS errors, map-matching inaccuracies, unavailability of floating car data from within tunnels etc. As the conventional systems and methods are subjected to several sources of inaccuracies, the inaccuracies potentially accumulate and result in inaccurate estimates of traffic speeds or travel times.

It is desired to address or ameliorate one or more disadvantages or limitations associated with the conventional systems and methods for traffic speed or travel time estimation, or to at least provide a useful alternative.

### SUMMARY

The disclosure provides a system for estimation of vehicle speed along a stretch of road, the system comprising:
one or more processors (processor(s));
a memory accessible to the processor(s), the memory comprising program code executable by the processor(s) to:
   compute a prior vehicle speed statistical distribution (prior distribution) based on historical vehicle speed data along the road;
   receive observed vehicle speed data relating to real-time or near real-time vehicle traffic along the road;
   perform Bayesian fusion of the prior distribution and the observed vehicle speed data by representing the prior distribution as a conjugate to a likelihood function to determine a posterior distribution;
   determine a vehicle speed estimate based on the posterior distribution.

The disclosure also provides a system for estimation of travel time, the system comprising:
one or more processor (processor(s));
a memory accessible to the processor(s), the memory comprising program code executable by the processor(s) to:
   receive an origin location, a destination location and a proposed time of travel from a computing device;
   determine a travel route between the origin location and the destination location, the travel route comprising at least one road segment;
   estimate the travel time by estimating a road segment travel time for each segment and adding the road segment travel times;
   wherein the road segment travel time is estimated by:
      computing a prior vehicle speed statistical distribution (prior distribution) based on historical vehicle speed data along the road segment;
      receiving observed vehicle speed data relating to real-time or near real-time vehicle traffic along the road segment;
      performing Bayesian fusion of the prior distribution and the observed speed data by representing the prior distribution as a conjugate to a likelihood function to determine a posterior distribution;
      determining an estimated vehicle speed estimate based on the posterior distribution;
   determining the road segment travel time based on the vehicle speed estimate and the road segment length.

The disclosure also provides a method for estimation of vehicle speed along a stretch of road, the method comprising:
computing a prior vehicle speed statistical distribution (prior distribution) based on historical vehicle speed data along the road;
receiving observed vehicle speed data relating to real-time or near real-time vehicle traffic along the road;
performing Bayesian fusion of the prior and the observed vehicle speed data by representing the prior distribution as a conjugate to a likelihood function to determine a posterior distribution;
determining a vehicle speed estimate based on the posterior distribution.

The disclosure also provides a method for estimation of travel time, the method comprising:
receiving an origin location, a destination location and a proposed time of travel from a computing device;
determining a travel route between the origin location and the destination location, the travel route comprising at least one road segment;
estimating the travel time estimate by estimating a road segment travel time for each segment and adding the road segment travel times;
wherein the travel time for each road segment is estimated by:
   computing a prior vehicle speed statistical distribution (prior distribution) based on historical vehicle speed data along the road segment;
   receiving a observed vehicle speed data relating to real-time or near real-time vehicle traffic along the road segment;
   performing Bayesian fusion of the prior distribution and the observed vehicle speed data by representing the prior distribution as conjugate to a likelihood function to determine a posterior distribution;
   determining a vehicle speed estimate based on the posterior vehicle speed distribution;
   determining the road segment travel time based on the vehicle speed estimate and the road segment length.

### BRIEF DESCRIPTION OF THE DRAWINGS

Exemplary embodiments of the present invention are illustrated by way of example in the accompanying drawings in which like reference numbers indicate the same or similar elements and in which:

FIG. 1 illustrates a block diagram of a system for vehicle speed and/or travel time estimation and its associated components;

FIG. 2 illustrates a flowchart for a method for vehicle speed estimation;

FIG. 3 illustrates a flowchart for a method for travel time estimation;

FIG. 4A illustrates a graph of a rolling average speed of vehicles as a function of a cumulative count of vehicles;

FIG. 4B illustrates a graph of speed values of vehicles obtained based on the data represented in graph 4A;

FIG. 4C represents a prior, observed and posterior vehicle speed statistical distribution determined in relation to the data of the graph of FIG. 4A; and

FIG. 5 illustrates a flowchart of a part of a method of generation of a prior vehicle speed statistical distribution.

### DETAILED DESCRIPTION

Traffic speed in urban environments is very dynamic, differs from region to region and is influenced by the prevailing conditions. A large number of variables impact how fast traffic moves in an area. The variables may be specific to a particular area within a city or a stretch of road. The large number of variables and degree of variability in factors that influence traffic speed makes the estimation of travel times a significant computational challenge. Accurate travel time estimation advantageously enables efficient allocation of vehicle or fleet resources in an urban area. Accurate travel time estimation also improves the quality of information made available to individuals reliant on a vehicle or vehicle fleet deployed in the urban area for transportation.

The present disclosure provides methods and systems for efficiently estimating travel times or traffic speeds based on a combination of historical data regarding traffic movement patterns and data obtained in real-time or near real-time from vehicles. The embodiments advantageously provide more accurate travel time or travel speed estimates for a vehicle in an urban area. For example, the embodiments allow the improved provision of estimates to users of a vehicle sharing service. The accurate travel time estimates also advantageously allow improved allocation of vehicles in a vehicle fleet to potential users of vehicles in an urban environment. Some embodiments may be implemented to estimate travel times of public transport services such as buses or shared vehicles etc. Advantageously, the embodiments also provide an estimate of travel time or travel speed that is responsive to on-ground traffic conditions such as accidents, congestions, roadblocks, etc. As traffic conditions in urban environments are subjected to unpredictable changes, the embodiments advantageously provide a more responsive system for estimation of travel time or travel speed.

Some embodiments also perform travel time estimation by receiving as input origin and destination locations and identifying a route/path between the origin and destination. The identified route is segmented into distinct road segments. A travel time estimate may be determined for each road segment and the total travel time estimate is determined as a sum of the individual travel time estimates.

Estimation methods described herein perform Bayesian fusion or Bayesian inference to provide a more accurate estimate of travel times or travel speeds. The travel time or vehicle speed is estimated using a combination of historical vehicle speed data and real-time or near real-time vehicle speed data gathered from a fleet of vehicles. Some embodiments exploit the mathematical convenience of conjugate priors, and the closed-form solution derived therefrom to obtain posterior estimates for road traffic conditions.

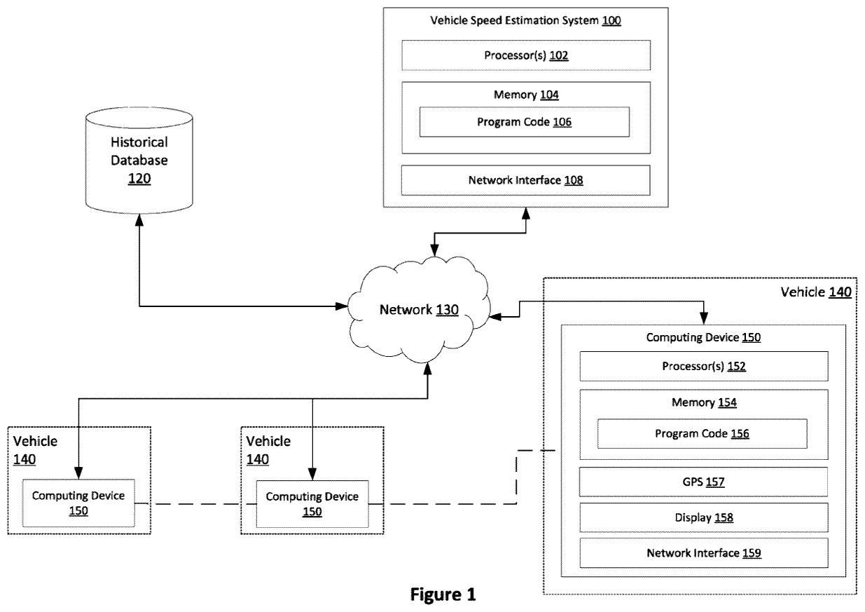

FIG. 1 illustrates a block diagram of a system 100 for estimation of vehicle speed or travel time along a stretch of road. The associated components include one or more vehicles 140. Associated with each vehicle is a computing device 150 that is configured to communicate with the system 100 over a network 130. In some embodiments, the computing device 150 may be a smartphone or a handheld computing device associated with the vehicle 140 to transmit information from the vehicle 140, the system 100, or receive information from the system 100. The computing device may transmit and receive data wirelessly through network 130 as the vehicle 140 navigates an area.

Also provided is a historical database 120 that stores historical vehicle speed or travel time information. Records within the historical database 120 may comprise one or more of the following attributes: a vehicle identifier, a vehicle trip identifier, a vehicle trip/travel time and date data, a vehicle trip start location data, a vehicle trip end location data, vehicle speed values etc. The records in the historical database 120 may be aggregated or categorized based on time of the day, day of the week and location values associated with the records—in this context, a location value is the location of a vehicle at the time the data about the vehicle (e.g. speed and time of day) was acquired. This categorization allows the determination of a prior vehicle speed statistical distribution specific to a particular time or time bracket of a particular day of the week. This prior vehicle speed statistical distribution provides a more focused starting point for estimation of travel time or vehicle speeds resulting in more accurate estimates.

The vehicle speed values stored in the historical database 120 are associated with a location or a stretch of road and thereby serve as an indication of the speed of traffic at a location or over a road segment. The historical database 120 may be populated using data that may be continuously or intermittently gathered from computing device 150 provided in a fleet of vehicles travelling in a region—a “fleet” as used herein may refer to a number of related vehicles such as taxis in a taxi company fleet, and/or a number of unrelated vehicles. The prior vehicle speed distribution obtained based on the records in the historical database 120 serves as a prior probability distribution for the Bayesian fusion operation performed by the vehicle speed estimation system 100.

The vehicle speed estimation system 100 comprises one or more processor(s) 102 configured to access a memory 104. Memory 104 stores program code 106 to implement the methods of travel time estimation. The vehicle speed estimation system 100 also comprises a network interface 108 to allow communication with the historical database 120, or the computing device(s) 150 or other relevant components over the network 120.

This disclosure contemplates computer system 100 taking any suitable physical or virtual form. The system 100 may include one or more computer systems 100; be unitary or distributed; span multiple locations; span multiple machines; span multiple data centers; or reside in a cloud, which may include one or more cloud components in one or more networks. Where appropriate, one or more systems 100 may perform without substantial spatial or temporal limitation one or more steps of one or more methods described or illustrated herein. One or more systems 100 may perform at different times or at different locations one or more steps of one or more methods described or illustrated herein, where appropriate.

The computing device 150 comprises one or more processor(s) 152 configured to access a memory 154 storing program code 156 to enable interaction between the computing device 150 and the system 100. The computing device 150 also comprises a network interface 159 to allow communication with the historical database 120, or the system 100 or other relevant components over the network 120. The computing device comprises a GPS sensor 157 to estimate the current position of the computing device 150 and thereby infer the location of the vehicle 140. The inferred location of the vehicle 140 and speed values based on the rate of change of location may be transmitted to the system 100 to provide real-time or near real-time vehicle speed information. Speed and/or location information obtained from a plurality of computing devices 150 provides the basis for computing the observed vehicle speed statistical distribution which is representative of traffic conditions in real-time or near real-time. The observed vehicle speed statistical distribution is computed in relation to a stretch of road or a road segment to provide a targeted representation of observed traffic conditions.

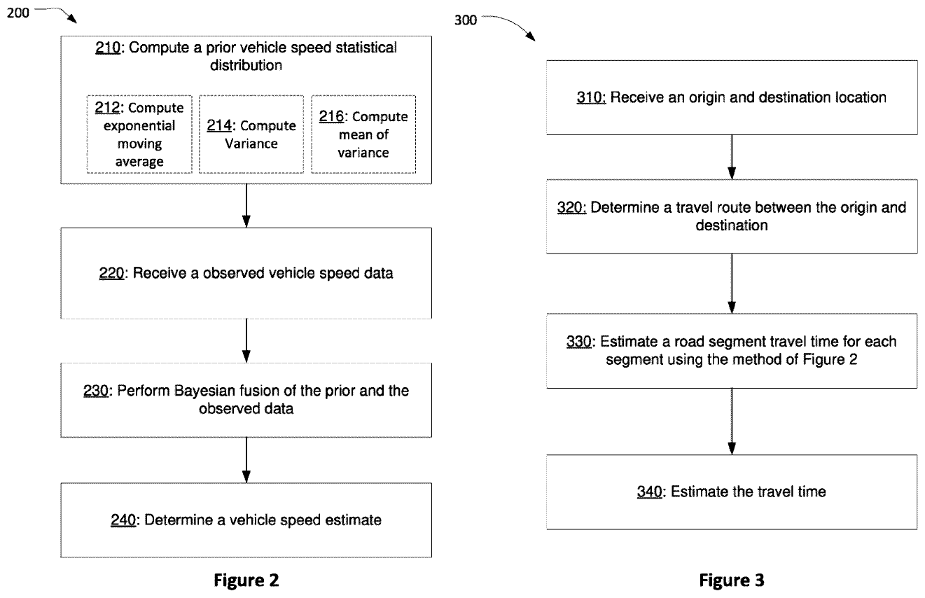

FIG. 2 illustrates a flowchart for a method 200 for vehicle speed estimation. The method 200 is executed by system 100. In particular, method 200 is executed by the processor(s) 102 by invoking the processing logic of the program code 106 in memory 104. Step 210 comprises computing a prior vehicle speed statistical distribution (prior distribution) based on historical vehicle speed data. The historical vehicle speed data relates to a stretch of road or a segment of road of interest for the computation and is retrieved from the historical database 120. The retrieved data may relate to vehicle speeds associated with a day of the week, a time of day associated with a time of estimation of the vehicle speeds. The time of day and/or day of the week may be selected to include the current time of day for a vehicle for which the speed is being estimated, or the time of day at which a vehicle is expected to reach each respective road segment. The prior vehicle speed statistical distribution models prior knowledge of vehicle speeds using previously captured floating car data. By computing the distribution based on historical data associated with a day of week and time of day, the system 100 advantageously obtains a more representative prior distribution relevant for the day and time at which the vehicle speed estimate is being computed.

Step 210 comprises sub-step 212 for computation of an exponential moving average. Sub-step 212 comprises the computation of the average vehicle speed along the road segment of interest and passing the average vehicle speeds through an exponential smoothing moving average function to capture historic travel patterns. The computed average may relate to vehicle speed data over a predefined period of historical data.

Step 210 comprises sub-step 214 for computation of variance of average speeds of vehicles over a predefined period for the road segment of interest. The computed variance is an indicator of the degree of variability of average speeds. A prior distribution with low variance is considered a strong prior and conversely, high variance indicates a high degree of uncertainty and lower confidence in the prior distribution.

Step 210 comprises the sub-step 216 of computation of mean of variance values. In particular, sub-step 216 comprises the computation of variance of speeds of individual vehicles over the road segment of interest and subsequently a determination of an average of the computed variance values over a predefined period.

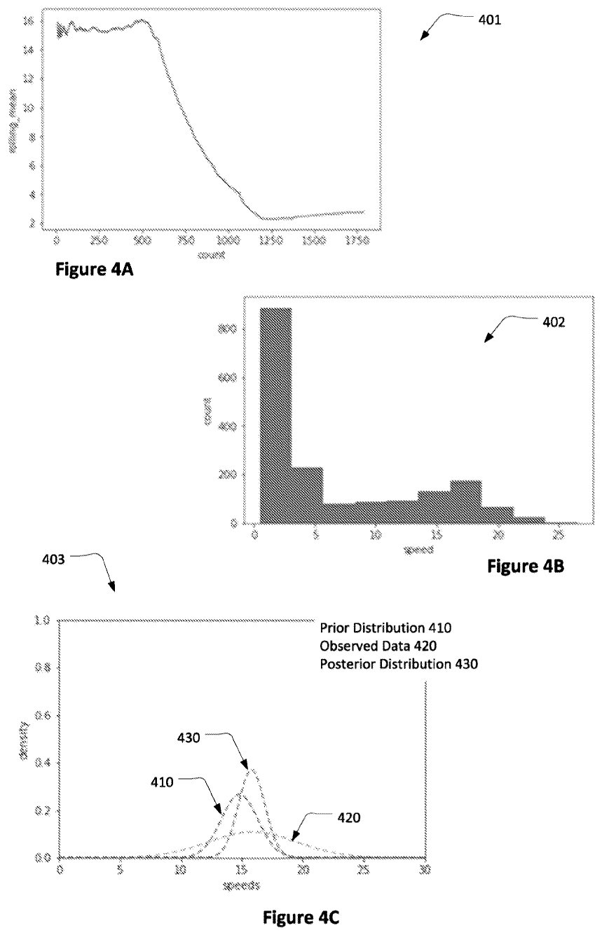

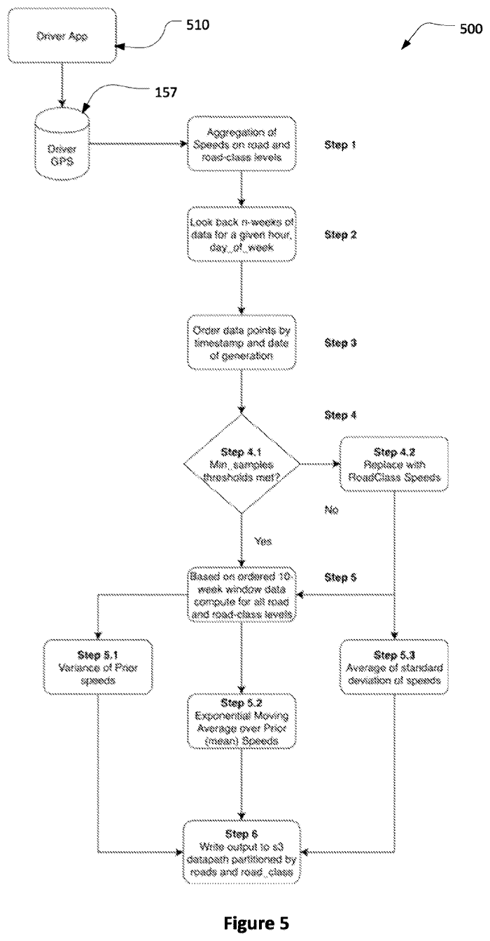

The predefined period used for the computations at sub-steps 212, 214 and 216 maybe 8 weeks, 10 weeks or 12 weeks, for example. The predefined period may be biased toward more recent data—e.g. the period may end at the present date or previous day, or the N most recently acquired data may be used for prior estimation, or a combination or formula of both. The computations at 212, 214 and 216 are used to define the prior vehicle speed statistical distribution which is used as a conjugate pair and fused with the observed vehicle speed statistical distribution computed at step 230. FIG. 4C illustrates a prior distribution 410 computed based on experimental data.

At step 220, observed vehicle speed data relating to real-time or near real-time vehicle traffic along the road segment of interest is received. The real-time or near real-time vehicle speed data may include vehicle data received within a recent period such as a period of last 5 minutes or last 15 minutes or last 30 minutes, for example. A suitable period may be selected based on the number of recent records. Based on the observed data, the average speed of vehicles within the recent period may be computed.

A sample count or the number of observations of vehicle speeds from the road segment of interest obtained in the recent period may be computed based on the observed vehicle speed data. In some embodiments, the weight allocated to the observed vehicle data during the fusion is proportional to the count of samples value. The count of samples value is used as a notion of confidence for the observed vehicle speed data. When a large number of samples are available, the fusion estimates tend to overweigh the observed data (i.e. real-time data). When a lower number of sample counts are available, the fusion estimates tend to overweigh prior distribution—this is because the greater number of samples in each case results in greater confidence in the data. The embodiments advantageously balance the consideration of the prior and the observed data to provide a more accurate estimate of vehicle speeds or travel time. FIG. 4C illustrates an observed data chart 420 computed based on received real-time, near real-time or recent vehicle speed data.

At step 230 Bayesian fusion of the prior and the observed data is performed to obtain a posterior vehicle speed distribution (posterior distribution). Given a likelihood and prior distribution, Bayes theorem states that posterior probability is proportional to the prior distribution times the likelihood term. However, the relationship captured by “proportional to” is vague to implement in a real-time system. System 100 is configured to assume that the likelihood and prior distributions are conjugate forms. System 100 determines a closed-form solution for the posterior distribution based on the variables/statistical attributes of prior and likelihood estimates. Under these constraints, “proportional” relationship translates to equivalence and hence is implementable in code.

Some conjugate pairs include Normal-Normal, Normal-Gamma distributions. System 100 uses Normal-Normal distribution approximation for both prior and likelihood distributions. System 100 performs the Bayesian fusion based on the principle that for sufficiently large “n”, distributions of sample means tend towards a Normal distribution (central limit theorem).

System 100 may implement methods such as Variational inference and MCMC (Markov Chain Monte Carlo) to infer the prior/posterior distributions as vehicle speed data is received in real-time or near real-time. Alternatively, system 100 may treat the distributions as normal distributions using the a rolling average of vehicle speeds as a mean of the normal distribution.

Assuming a Normal-Normal distribution for both prior and likelihood (observed) distributions, the posterior hyperparameters may be represented as:

$$\frac{1}{\frac{1}{{σ}_{0}^{2}} + \frac{n}{{σ}^{2}}} ( \frac{{μ}_{0}}{{σ}_{0}^{2}} + \frac{{\sum }_{i = 1}^{n} {x}_{i}}{{σ}^{2}} ) , {( \frac{1}{{σ}_{0}^{2}} + \frac{n}{{σ}^{2}} )}^{- 1}$$

where μ₀ (mean) and σ₀² (variance) relate to the prior distribution, σ² is the observed vehicle speed variance, n is the number of observations and xᵢ is an observation i among the n observations. FIG. 4C illustrates a posterior distribution 430 computed based on the prior distribution 410 and the observed vehicle speed data 420.

The posterior distribution determined at step 230 may be used as an experimental prior distribution for further experiments and estimation of vehicle speeds or travel times for a future period in an online-learning setting. A time to live may be assigned to the posterior distribution determined at step 230 after which the posterior distribution is considered invalid and an updated posterior distribution is computed by execution of method 200 with updated historical and/or real-time or near real-time data. By periodically updating the posterior distribution, the system 100 factors in the most recent vehicle speed data with the relevant historical vehicle speed data to provide a more accurate estimate of vehicle speeds and travel times.

At step 240, system 100 determines a vehicle speed estimate based on the computed posterior distribution. The vehicle speed estimate could be the mean of the posterior distribution or a range of estimated vehicle speeds defined based on the mean and the standard deviation of the posterior distribution.

FIG. 3 illustrates a flowchart of a method 300 for travel time estimation. The method 300 incorporates the method 200. At step 310, the system 100 receives an origin location and a destination location from a requesting computing device 150. The origin and destination locations may be received as part of a transport hailing service request described in the PCT publication WO 2020046200 A1 titled “E-hailing service”. The origin and destination locations may be received as part of a service request described in the PCT publication WO 2018208232 A1 titled “Allocation of dynamically batched service providers and service requesters”.

At step 320, system 100 determines a travel route between the origin location and the destination location. The travel route comprises at least one road segment. A longer route may be broken down into multiple road segments. Each road segment serves as a basis or criterion for computation of the prior and observed vehicle speed distributions and subsequent fusion of the two distributions to determine a posterior distribution for each road segment. By breaking down the route into one or more road segments, the system 100 advantageously simplifies a complex travel time estimation problem into distinct less complex travel time estimation problems associated with specific road segments.

In some embodiments, the system 100 may determine the travel route based on the apparatuses and methods for processing route information described in the PCT Publication WO 2020263176 A1 titled “Processing route information” the contents of which are hereby incorporated by reference. In some embodiments, the system 100 may determine the travel route based on the apparatuses and methods for generating route navigation data described in the PCT Publication WO 2022031222 A1 titled “Processing apparatus and method for generating route navigation data” the contents of which are hereby incorporated by reference. In some instances, the system may identify one or more routes between an origin and destination, and estimate a travel time for each route. The system 100 may then recommend a route with the lowest aggregate travel time (i.e. sum of the times for travelling each segment of the respective route).

At step 330, the system 100 estimates a vehicle speed estimate for each road segment identified in step 320 by executing method 200 for each of the road segments. Based on the estimated vehicle speeds, the system 100 estimates a travel time or an estimated range of travel time for each road segment. At step 340, the system 100 estimates a total travel time or a total travel time range estimate based on a sum of the travel times estimated at step 330. The total travel time estimate may be transmitted by the system to a requesting computing device 150 which may subsequently display the estimate on its display 158 for a user.

FIG. 4A illustrates a graph 401 of rolling average speeds of vehicles as a function of a cumulative count of vehicles reporting the average speed in relation to observed traffic conditions. Graph 401 illustrates prior speed of between 14 to 16 km/hr when a smaller number of vehicles were at play. Progressively the rolling average speed falls to between 2 to 4 km/hr due to traffic congestion incidents in the area. FIG. 4B illustrates a graph 402 of speeds of vehicles obtained for the same experimental conditions that were the source of the data for FIG. 4A. FIG. 4B illustrates two peaks one between the 0 to 4 km/hr (post congestion peak) and another between the 15 to 20 km/hr (pre congestion peak).

FIG. 4C represents a graph 403 including a prior 410, observed 420 and posterior 430 vehicle speed statistical distributions determined in relation to the data that formed the basis for the graphs of FIGS. 4A and 4B. The posterior distribution 430 serves as a basis for estimation of vehicle speeds and travel times by taking into account the prior and the observed vehicle speed data.

FIG. 5 illustrates a flowchart of a part of a method 500 of generation of a prior vehicle speed statistical distribution. The driver app 510 is a smartphone application installed on the computing device 150 that triggers the periodic transmission of the data received from GPS 157 to the system 100 or the historical database 120. Steps 1 to 6 are performed by the system 100 based on the data received from the GPS 157 of a plurality of computing devices 150. At step 1 the system 100 aggregates speed data based on roads, road segments or classes of roads. Classes of roads may relate to a category or a type of road in an urban area, country area, sealed, unsealed and so on, so as to be generally reflective of the patterns or speed of traffic on roads in a class. Step 2 comprises retrieving historical data over a period of n weeks for a given hour of the day and the day of the week. At step 3, the system 100 orders the data points based on the timestamp and the date at which the data points were generated.

At step 4.1, the system 100 evaluates whether a minimum number of samples associated with a road segment are available to generate a statistically meaningful prior distribution. If a sufficient number of samples are not available, then at step 4.2 the data points for a relevant road class are used to generate the prior distribution. The data from the relevant road class may be used in place of the samples, or may be added to the samples such that there is a sufficient number of data points (or records) to generate a meaningful prior distribution. However, if a sufficient number of samples are available, then at step 5, various statistical metrics representative of the prior distribution are calculated as described with reference to step 210 of FIG. 2. At step 6, the output of the steps 5.1, 5.2 and 5.3 is stored/written on the memory 104 of the system 100. The “sufficient number” may be a predetermined number.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Although this disclosure describes or illustrates particular embodiments as providing particular advantages, particular embodiments may provide none, some, or all of these advantages.

1. A system for estimation of vehicle speed along a stretch of road, the system comprising:
one or more processors (processor(s));
a memory accessible to the processor(s), the memory comprising program code executable by the processor(s) to:
compute a prior vehicle speed statistical distribution (prior distribution) based on historical vehicle speed data along the road;
receive observed vehicle speed data relating to real-time or near real-time vehicle traffic along the road;
perform Bayesian fusion of the prior distribution and the observed vehicle speed data by representing the prior distribution as a conjugate to a likelihood function to determine a posterior distribution;
determine a vehicle speed estimate based on the posterior distribution.

2. The system of claim 1, wherein the fusion of the prior distribution and the observed vehicle speed data comprises exponential smoothing of the prior vehicle statistical distribution to incorporate the observed vehicle speed data.

3. The system of claim 1, wherein the prior distribution is computed based on historical vehicle data for a time of the day and a day of the week associated with a time of estimation of the vehicle speed.

4. The system of claim 1, wherein the processor(s) performs Bayesian fusion of the prior distribution and the observed vehicle speed data by computing hyperparameters, the hyperparameters comprising at least one of:
variance of historical vehicle speed data;
exponential moving average of historical vehicle speed data;
average of standard deviations of the historical vehicle speed data; mean of real-time or near real-time vehicle speed data; and
a count of samples in the real-time or near real-time vehicle speed data; wherein the computed hyperparameters define a closed-form solution as a Normal-Normal conjugate pair of the prior and posterior distributions to perform the Bayesian fusion.

5. The system of claim 4, wherein a weight allocated to the observed vehicle speed data during the fusion is proportional to a count of samples of received observed vehicle speeds.

6. The system of claim 1, wherein the processor(s) infers a distribution of the observed vehicle speed data using Markov chain Monte Carlo (MCMC) method or a variational interference method.

7. The system of claim 1, wherein the fusion of the prior and the observed vehicle seed data is performed by modelling the prior and the posterior vehicle speed distributions as normal distributions.

8. The system of claim 1, wherein the Bayesian fusion is performed in real-time or near real-time as the observed vehicle speed data is received.

9. A system for estimation of travel time, the system comprising:
one or more processor (processor(s));
a memory accessible to the processor(s), the memory comprising program code executable by the processor(s) to:
receive an origin location, a destination location and a proposed time of travel from a computing device;
determine a travel route between the origin location and the destination location, the travel route comprising at least one road segment; estimate the travel time by estimating a road segment travel time for each segment and adding the road segment travel times;
wherein the road segment travel time is estimated by: computing a prior vehicle speed statistical distribution (prior distribution) based on historical vehicle speed data along the road segment;
receiving observed vehicle speed data relating to real-time or near real-time vehicle traffic along the road segment; performing Bayesian fusion of the prior distribution and the observed speed data by representing the prior distribution as a conjugate to a likelihood function to determine a posterior distribution;
determining an estimated vehicle speed estimate based on the posterior distribution;
determining the road segment travel time based on the vehicle speed estimate and the road segment length.

10. The system of claim 9, wherein the processor(s) is further configured to transmit the estimate travel time to the computing device.

11. the system of claim 10, wherein the computing device further comprises:
one or more computing device processor (computing device processor(s));
a memory accessible to the computing device processor(s), the memory comprising program code executable by the computing device processor(s) to:
transmit an origin location, a destination location and a proposed time of travel to the system;
receive an estimated travel time from the system.

12. A method for estimation of vehicle speed along a stretch of road, the method comprising:
computing a prior vehicle speed statistical distribution (prior distribution) based on historical vehicle speed data along the road;
receiving observed vehicle speed data relating to real-time or near real-time vehicle traffic along the road;
performing Bayesian fusion of the prior and the observed vehicle speed data by representing the prior distribution as a conjugate to a likelihood function to determine a posterior distribution;
determining a vehicle speed estimate based on the posterior distribution.

13. A method for estimation of travel time, the method comprising:
receiving an origin location, a destination location and a proposed time of travel from a computing device;
determining a travel route between the origin location and the destination location, the travel route comprising at least one road segment;
estimating the travel time estimate by estimating a road segment travel time for each segment and adding the road segment travel times;
wherein the travel time for each road segment is estimated by:
computing a prior vehicle speed statistical distribution (prior distribution) based on historical vehicle speed data along the road segment;
receiving a observed vehicle speed data relating to real-time or near real-time vehicle traffic along the road segment;
performing Bayesian fusion of the prior distribution and the observed vehicle speed data by representing the prior distribution as a
conjugate to a likelihood function to determine a posterior distribution;
determining a vehicle speed estimate based on the posterior vehicle speed distribution;
determining the road segment travel time based on the vehicle speed estimate and the road segment length.

14. One or more non-transitory computer-readable storage media storing instructions that when executed by one or more processors cause the one or more processors to perform the method of claim 12.
